(19) United States
(12) Patent Application Publication
(10) Pub. No.: US 2025/0162677 A1
(43) Pub. Date: May 22, 2025

(54) Method and Device for Determining the Load State of a Motorcycle

(71) Applicant: Bayerische Motoren Werke Aktiengesellschaft, Muenchen (DE)

(72) Inventor: Jasper SMEETS, Muenchen (DE)

(21) Appl. No.: 18/832,142

(22) PCT Filed: Mar. 20, 2023
(86) PCT No.: PCT/EP2023/057054

§ 371 Date: Jul. 23, 2024

(30) Foreign Application Priority Data
Apr. 7, 2022 (DE) 10 2022 108 403.5

(51) Int. Cl. B62J 45/41; B62K 25/04

(52) U.S. Cl. CPC B62J 45/41; B62K 25/04; B62K 2025/044

(57) ABSTRACT

A device for determining a state of a single-track vehicle. The device is designed to capture, during a usage situation of the vehicle, measurement values of spring forces of a suspension system of a front wheel and of a suspension system of a rear wheel of the vehicle and to determine, on the basis of the measurement values of the spring forces, estimated values of a plurality of state variables of the vehicle, which each relate to the load of the vehicle. The device is also designed to operate the vehicle on the basis of the estimated values of the state variables, and/or to provide the estimated values of the state variables or data based thereon to a unit which is external to the vehicle.

### BACKGROUND AND SUMMARY

This disclosure relates to a method and to a corresponding device for determining the load state and/or a usage scenario of a motorcycle.

A motorcycle can be used by a user in different ways, for example for riding alone, for riding with a pillion passenger and/or for riding with luggage. The respective usage scenario typically has effects on the riding behavior of the motorcycle and thus on riding comfort and/or on riding safety.

The present document deals with the technical problem of efficiently and reliably increasing riding comfort and/or riding safety of a motorcycle.

According to one aspect, a description is given of a device for determining a (load and/or usage) state of a single-track vehicle, in particular a motorcycle. The device is configured, during a usage situation of the vehicle (for example during a journey of the vehicle), to determine measurement values of spring forces of a suspension system of the front wheel and a suspension system of the rear wheel of the vehicle. In particular, a measurement value F_{s,f} of the spring force of the suspension system of the front wheel and a measurement value F_{s,r} of the spring force of the suspension system of the rear wheel can be determined. For this purpose, the suspension state (for example the deflection along the suspension direction) of the front-wheel suspension system and/or the suspension state (for example the deflection along the suspension direction) of the rear-wheel suspension system can be determined, for example using sensors. The measurement value of the respective spring force can then be determined (for example taking into account the spring constants of the respective suspension system) based on the respective suspension state (for example based on the deflection of the respective suspension system). The measurement values of the spring forces can be determined for a particular (current) time. The spring forces may also act along the suspension direction of the respective suspension device. In this case, the suspension direction of a suspension system typically deviates from the vertical direction (vertically to the roadway and/or to the ground).

The device is also configured to determine, on the basis of the measurement values of the spring forces, estimated values of a plurality of state variables of the vehicle, which estimated values each relate to the load of the vehicle. The state variables may include the mass m of the vehicle and/or the position x_{cog} of the center of gravity of the vehicle (in the horizontal direction, parallel to the roadway and/or parallel to the ground).

The estimated values of the one or more state variables of the vehicle may be determined precisely using one or more (analytical) state variable models. In this case, the one or more state variable models may each have one or more model parameters. Examples of model parameters are: the vertical acceleration a_{z} of the vehicle (at the current time) in the vertical direction, the roll angle δ of the vehicle (at the current time) about the longitudinal axis of the vehicle, and/or the aerodynamic force Fₐₑᵣₒ acting on the vehicle (at the current time) and typically acting in the horizontal direction.

The device may be configured to determine values of the one or more model parameters (for example using one or more sensors of the vehicle) and to use same to determine the estimated values of the one or more state variables of the vehicle. The estimated values of the one or more state variables can thus be determined particularly precisely.

The one or more state variable models may include (to determine the estimated value of the mass m)

$$m = \frac{{a}_{z} * g * ( {F}_{z , f} + {F}_{z , r} )}{cos ( δ )}$$

wherein g is the gravitational field strength; wherein F_{z,f} is the measurement value of a vertical force of the suspension system of the front wheel (in the vertical direction), which is dependent on the measurement value of the spring force of the suspension system of the front wheel; and wherein F_{z,r} is the measurement value of a vertical force of the suspension system of the rear wheel (in the vertical direction), which is dependent on the measurement value of the spring force of the suspension system of the rear wheel.

The one or more state variable models may include (to determine the estimated value of the position x_{cog} of the center of gravity of the vehicle)

$${x}_{cog} = \frac{{x}_{wb} * {F}_{z , r} - {z}_{l} * {F}_{aero}}{m * g}$$

wherein x_{wb} is the horizontal distance between the axle of the front wheel and the axle of the rear wheel of the vehicle; and wherein zₗ is the effective height (of the roadway and/or ground) at which the aerodynamic force acts on the vehicle (which for example has been determined beforehand through experiments).

The estimated values of the one or more state variables can be determined particularly precisely by using one or more of the aforementioned state variable models.

The device is also configured to operate the vehicle depending on the estimated values of the state variables, and/or to provide the estimated values of the state variables or data based thereon to a unit external to the vehicle. For example, during the usage situation of the vehicle, one or more operating parameters of the vehicle can be set depending on the estimated values of the state variables. As an alternative or in addition, estimated values of the state variables can be used by the unit external to the vehicle in order to develop a new vehicle and/or in order to mechanically and/or electronically change one or more components of the vehicle. The comfort and/or the riding safety of single-track vehicles can thus be increased efficiently and reliably.

The device may be configured to determine, on the basis of the measurement values of the spring forces and based on a speed ratio of the suspension system of the front wheel and/or a speed ratio of the suspension system of the rear wheel of the vehicle, corresponding measurement values of the vertical forces, which act on the front wheel and on the rear wheel of the vehicle in the vertical direction. The vertical direction in this case may correspond to the direction in which the force of gravity of the Earth is acting. As an alternative, the vertical direction may correspond to the direction vertical to the roadway on which the vehicle is traveling. The speed ratio of the suspension system of the front wheel and/or the speed ratio of the suspension system of the rear wheel may have been determined for the usage situation beforehand (through experiments).

The device may be configured to determine, in particular, on the basis of the measurement value F_{s,f} of the spring force of the suspension system of the front wheel (along the suspension direction of the suspension system) and based on the speed ratio τ_{f} of the suspension system of the front wheel, the corresponding measurement value F_{z,f} of the vertical force on the front wheel, in particular as F_{z,r}=F_{s,r}*τᵣ.

In a corresponding manner, the device may be configured to determine, on the basis of the measurement value F_{s,r} of the spring force of the suspension system of the rear wheel and based on the speed ratio τᵣ of the suspension system of the rear wheel, the corresponding measurement value F_{z,r} of the vertical force on the rear wheel, in particular as F_{z,r}=F_{s,r}*τᵣ.

The estimated values of the state variables can then be determined particularly precisely on the basis of the measurement values of the vertical forces. In particular, the estimated values of the state variables can be determined on the basis of the measurement value F_{z,f} of the vertical force on the front wheel and on the basis of the measurement value F_{z,r} of the vertical force on the rear wheel.

The speed ratio of the suspension system may depend on the ratio between the suspension travel along the suspension direction of the suspension system and the vertical travel, corresponding to the suspension travel, along the vertical direction. In this case, Xₛ₁-Xₛ₂ may be the suspension travel of the suspension system of the front wheel or the rear wheel between a first suspension state and a second suspension state of the suspension system. Furthermore, Z_{w2}-Z_{w1} may be the corresponding vertical travel of the front wheel or the rear wheel between the first suspension state and the second suspension state of the suspension system (which results in the presence of the suspension travel Xₛ₁-Xₛ₂). The speed ratio τ of the suspension system of the front wheel or the rear wheel may then be determined as

$$τ = \frac{{X}_{s 1} - {X}_{s 2}}{{Z}_{w 2} - {Z}_{w 1}}$$

The device may be configured, at a sequence of successive times (repeatedly, in particular periodically), to determine respective current measurement values of the spring forces. The estimated values of the state variables can then be updated using a recursive determination unit (for example using a recursive at least square (RLS) filter) on the basis of the respective current measurement values of the spring forces. Estimated values of the state variables can thus be determined particularly precisely in a recursive manner.

The device may be configured to select, on the basis of the estimated values of the state variables, a usage scenario of the vehicle in the usage situation from a set of different usage scenarios. For this purpose, a machine-trained classification unit may be used. The set of different usage scenarios may include: a first usage scenario in which a rider is riding alone without luggage; a second usage scenario in which the rider is riding with a pillion passenger; a third usage scenario in which the rider is riding alone with luggage; and/or a fourth usage scenario in which the rider is riding with a pillion passenger and with luggage.

The vehicle may then be operated particularly precisely based on the selected usage scenario. As an alternative or in addition, the selected usage scenario may then be provided to the unit external to the vehicle, for example in order to enable to particularly reliable development of a new type of vehicle.

According to a further aspect, a description is given of a device for determining a usage scenario of a single-track vehicle, in particular a motorcycle. The features described in this document may be incorporated into this device in each case individually or in combination.

The device is configured, during a usage situation of the vehicle, to determine estimated values of a plurality of state variables of the vehicle, which estimated values relate to a load of the vehicle. The device is also configured to select, on the basis of the estimated values of the state variables, a usage scenario of the vehicle in the usage situation from a set of different usage scenarios. The device is furthermore configured to operate the vehicle depending on the selected usage scenario, and/or to provide the selected usage scenario to a unit external to the vehicle.

According to a further aspect, a description is given of a (road) motor vehicle (in particular a motorcycle) that comprises at least one of the devices described in this document.

According to a further aspect, a description is given of a method for determining a state of a single-track vehicle, in particular a motorcycle. The state in this case may be described by one or more state variables. The method, during a usage situation of the vehicle, comprises determining measurement values of spring forces of a suspension system of the front wheel and a suspension system of the rear wheel of the vehicle. The method further comprises determining, on the basis of the measurement values of the spring forces, estimated values of a plurality of state variables of the vehicle, which estimated values each relate to the load of the vehicle. The method furthermore comprises operating the vehicle depending on the estimated values of the state variables, and/or providing the estimated values of the state variables or data based thereon to a unit external to the vehicle.

According to a further aspect, a description is given of a method for determining a usage scenario of a single-track vehicle, in particular a motorcycle. The method, during a usage situation of the vehicle, comprises determining estimated values of a plurality of state variables of the vehicle, which estimated values each relates to a load of the vehicle (with a fellow passenger and/or with luggage). The method furthermore comprises selecting, based on the estimated values of the state variables, a usage scenario of the vehicle in the usage situation from a set of different usage scenarios. The method also comprises operating the vehicle depending on the selected usage scenario, and/or providing the selected usage scenario to a unit external to the vehicle.

According to a further aspect, a description is given of a software (SW) program. The SW program may be configured to be executed on a processor (for example on a control unit of a vehicle) and in order thereby to carry out one of the methods described in this document.

According to a further aspect, a description is given of a storage medium. The storage medium may comprise an SW program that is configured to be executed on a processor and in order thereby to carry out at least one of the methods described in this document. The storage medium may comprise a memory (for example, ROM, RAM, PROM, EPROM, EPROM, etc., or a hard disk).

It should be noted that the methods, devices and systems described in this document may be used both on their own and in combination with other methods, devices and systems described in this document. Moreover, any aspects of the methods, devices and systems described in this document may be combined with one another in a wide variety of ways. In particular, the features of the claims may be combined with one another in a wide variety of ways. Features introduced in parentheses should also be understood as being optional features.

### BRIEF DESCRIPTION OF THE DRAWINGS

The disclosure is described in more detail below with reference to exemplary embodiments.

FIG. 1 shows an example of a motorcycle;

FIGS. 2a to 2c show examples of physical variables on a motorcycle;

FIG. 3a shows an example of a determination unit for determining the estimated value of a state variable of the motorcycle;

FIG. 3b shows an example of a time profile of the estimated value of a state variable;

FIG. 4 shows examples of clusters for different usage scenarios;

FIG. 5a shows a flowchart of an example of a method for determining state variables of a motorcycle; and,

FIG. 5b shows a flowchart of an example of a method for determining a usage scenario of a motorcycle.

### DETAILED DESCRIPTION OF THE DRAWINGS

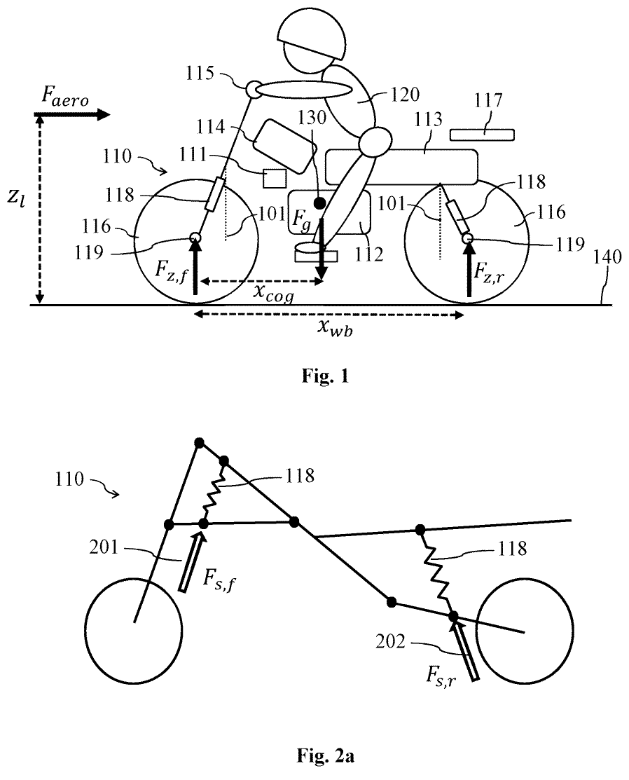

As stated at the outset, the present document deals with the increase in riding comfort and/or riding safety of a motorcycle, or generally a single-track vehicle. In this context, FIG. 1 shows exemplary components of a motorcycle 110 as an example of a (single-track) vehicle. The motorcycle 110 comprises wheels 116, in particular a front wheel and a rear wheel, which each rotate about a wheel axle 119. The front wheel 116 may be steered using a steering handle 115. The motorcycle 110 furthermore comprises a drive motor 112 (for example an Otto engine and/or an electric machine). The motorcycle 110 also comprises an energy storage unit 114 (for example a fuel tank) and a seat or seat bench 113 for one or more users (in particular for a rider and possibly for a pillion passenger) 120 of the motorcycle 110. The motorcycle 110 may furthermore comprise a luggage rack 117 for luggage. FIG. 1 also shows an example of a control device 111 of the motorcycle 110, which control device may be configured to carry out one of the methods described in this document.

The front wheel 116 may be connected to the frame of the motorcycle 110 via a suspension system 118. The rear wheel 116 may correspondingly have a suspension system 118. The suspension systems 118 may each typically have an angle relative to the verticals 101 (which is oriented vertically to the ground and/or to the roadway 140), which is not equal to zero. In other words, the suspension direction of a suspension system 118 typically deviates from the vertical direction.

When the motorcycle 110 rides over a roadway 140, a vertical spring force F_{z,f} acts on the axle 119 of the front wheel 116 and a vertical spring force F_{z,r} acts on the axle 119 of the rear wheel 116. An aerodynamic force Fₐₑᵣₒ also acts on the motorcycle 110 (in the horizontal direction) at an effective height zₗ. A gravitational force F_{g}=m*g (along the vertical 101) furthermore acts on the center of gravity 130 of the motorcycle 110, with m being the mass of the motorcycle 110.

In FIG. 1, x_{wb} denotes the distance between the front-wheel axle 119 and the rear-wheel axle 119. Furthermore, x_{cog} denotes the distance between the center of gravity 130 (in the horizontal direction) and the front-wheel axle 119.

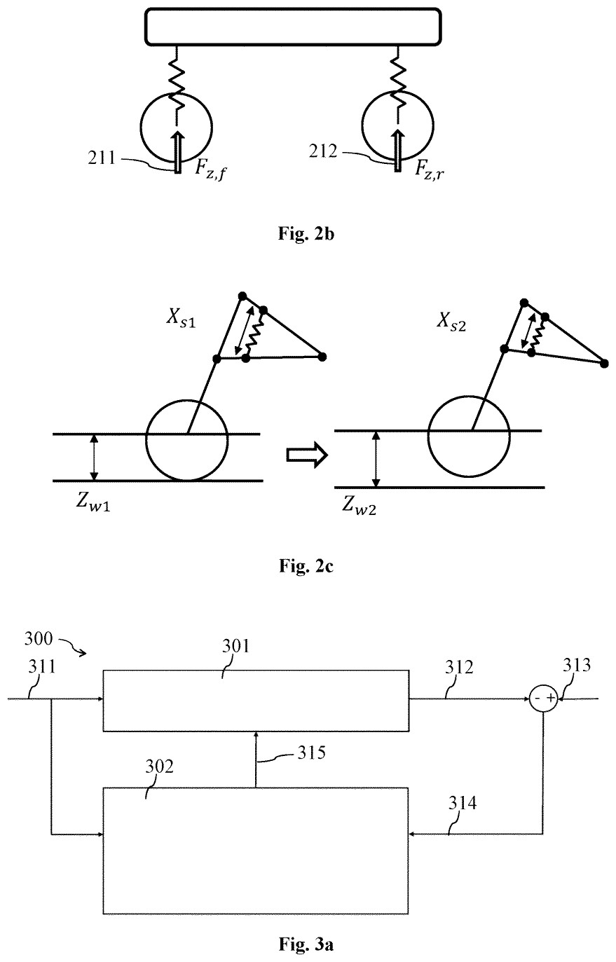

FIG. 2a illustrates a model of the motorcycle 110 from FIG. 1 with the front-wheel suspension system 118 and the rear-wheel suspension system 118, wherein, during a journey, the (non-vertical) spring force F_{s,f} 201 acts on the front-wheel suspension system 118 and the (non-vertical) spring force F_{s,r} 202 acts on the rear-wheel suspension system 118. The forces 201, 202 each act in the (suspension) direction of the respective suspension system 118. The suspension systems 118 may be configured to provide measurement values in relation to the respective spring force 201, 202 (for example in each case at a particular measuring rate).

The corresponding vertical forces F_{z,f} 211 and F_{z,r} 212 can be determined on the basis of the spring forces 201, 202 (as illustrated in FIG. 2b). The respective speed ratio T of the respective suspension system 118 can be used for this purpose. For the vertical forces 211, 212, the following hold true

F_{z,f}=F_{s,f}*τ_{f}

F_{z,r}=F_{s,r}*τᵣ

where if is the speed ratio of the front-wheel suspension system 118 and τᵣ is the speed ratio of the rear-wheel suspension system 118.

FIG. 2c illustrates the determination of the speed ratio of the front-wheel suspension system 118. Here, a first suspension state of the suspension system 118 is taken into consideration (on the left), in which the suspension system 118 has a first suspension length Xₛ₁, which leads to a first vertical axle spacing Z_{w1} with respect to a reference plane. A second suspension state of the suspension system 118 with a second suspension length Xₛ₂ and the second vertical axle spacing Z_{w2} brought about thereby is also taken into consideration. The speed ratio can then be determined as

$$τ = \frac{{X}_{s 1} - {X}_{s 2}}{{Z}_{w 2} - {Z}_{w 1}} .$$

The speed ratio of the rear-wheel suspension system 118 can be determined in a corresponding manner.

The measurement values of the spring forces 201, 202 can therefore be converted into measurement values of the vertical forces 211, 212. The speed ratios of the suspension systems 118 may in this case be determined beforehand.

The measurement values of the vertical forces 211, 212 can be used to determine values of one or more state variables of the motorcycle 110. In particular, the value of the mass m of the motorcycle 110 can be determined, for example, as

$$m = \frac{{a}_{z} * g * ( {F}_{z , f} + {F}_{z , r} )}{cos ( δ )}$$

wherein g is the gravitational acceleration and/or the gravitational field strength, wherein a_{z} is the vertical acceleration of the motorcycle 110 (in the vertical direction), and wherein δ is the angle of inclination or roll angle of the motorcycle 110. The motorcycle 110 may comprise one or more sensors (not illustrated), which make it possible to determine a measurement value and/or estimated value of the roll angle δ and/or the vertical acceleration a_{z} of the motorcycle 110.

The location x_{cog} of the center of gravity 130 of the motorcycle 110 can be determined as another state variable, for example from the following state variable model

$${x}_{cog} = \frac{{x}_{wb} * {F}_{z , r} - {z}_{l} * {F}_{aero}}{m * g}$$

wherein zₗ is the reference height at which the aerodynamic force Fₐₑᵣₒ takes effect. The aerodynamic force Fₐₑᵣₒ can be determined on the basis of the riding speed of the motorcycle 110.

Estimated values for one or more state variables, in particular for the mass m and/or for the (horizontal) position x_{cog} of the center of gravity 130, of the motorcycle 110 can thus be determined on the basis of the measurement values of the spring forces 201, 202, which estimated values relate to the current usage situation of the motorcycle 110.

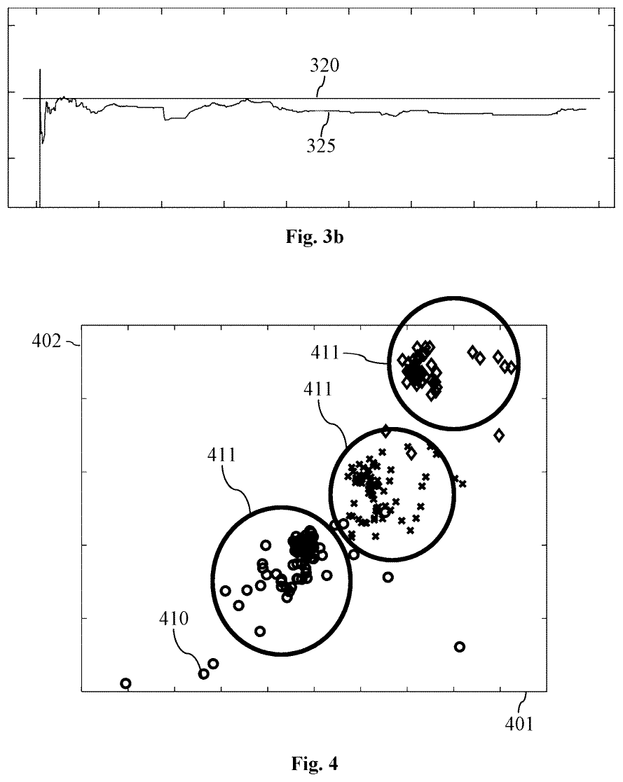

The individual measurement values of the spring forces 201, 202 may in each case include measurement noise, which adversely affects the accuracy of the determined estimated values for the one or more state variables. FIG. 3a shows an example of a determination unit 300 that makes it possible to determine an estimated value of a state variable with an increased degree of accuracy in an iterative and/or recursive manner, on the basis of the measurement values of the spring forces 201, 202 for a sequence of successive times. For this purpose, the determination unit 300 uses, for example, an RLS (recursive least squares) filter. Any of the units (e.g., 300, 301, 302, etc.) described herein may be implemented with the described processor and/or SW program(s).

The determination unit 300 illustrated in FIG. 3a uses an estimation unit 301, which is configured to determine, on the basis of the respective current estimated value 315 of the state variable and on the basis of the (measurement) values 311 of one or more model parameters (for example the vertical acceleration a_{z}, the roll angle δ, the aerodynamic force Fₐₑᵣₒ, etc.), current estimated values 312 for the spring forces 201, 202 (or the vertical forces 211, 212), which current estimated values are compared with the current measurement values 313 of the spring forces 201, 202 (or the vertical forces 211, 212) in order to determine a current error value 314. The current error value 314 can be used by an update unit 302 to update the estimated value 315 of the state variable. The estimation unit 301 can use one of the state variable models described in this document.

FIG. 3b illustrates how the determination unit 300 can be used to determine, in a recursive manner based on the measurement values 313 of the spring forces 201, 202 (or the vertical forces 211, 212) for a sequence of times, a time profile 315 of estimated values 315 of a state variable, which time profile converges on the actual value 320 of the state value relatively precisely.

It is thus possible to determine estimated values 315 for a plurality of state variables, in particular for the mass and for the position of the center of gravity 130, of the motorcycle 110. The estimated values 315 of the state variables can be used to identify the current usage scenario of the motorcycle 110 from a set of predefined usage scenarios. Examples of usage scenarios are
a first usage scenario in which the rider is riding alone without luggage;
a second usage scenario in which the rider is riding with a pillion passenger;
a third usage scenario in which the rider is riding alone with luggage; and/or
a fourth usage scenario in which the rider is riding with a pillion passenger and with luggage.

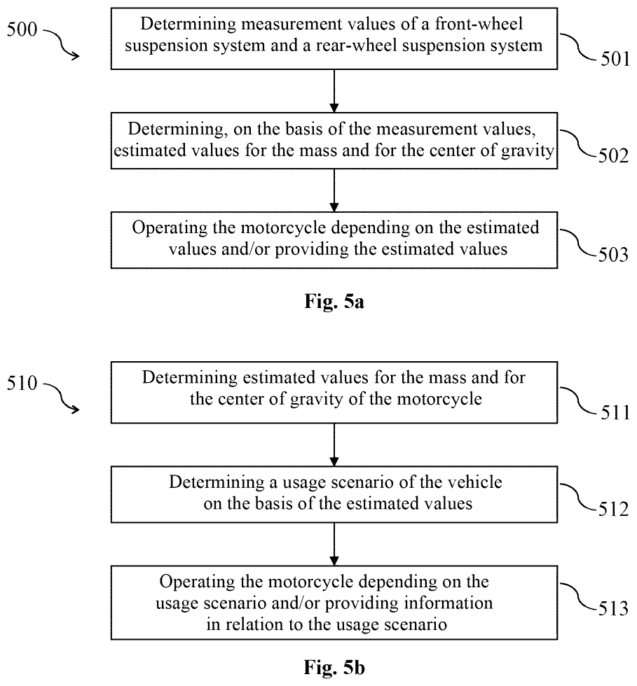

The device 111 of the motorcycle 110 may be configured to determine the current usage scenario on the basis of the estimate values 315 of the state variables using an, in particular machine-trained, classification unit. FIG. 4 shows examples of measurement points 410 of a multiplicity of uses of the motorcycle 110. A measurement point 410 in this case has a plurality of coordinates 401, 402, wherein the individual coordinates 401, 402 each correspond to a state variable. The estimated values 315 of N state variables (where N≥2) can therefore be combined to form an N-dimensional measurement vector, wherein the measurement vector corresponds to a measurement point 410 in an N-dimensional space. FIG. 4 shows an example of N=2 state variables, wherein the first coordinate 401 corresponds, for example, to the center of gravity 130 and wherein the second coordinate 402 corresponds, for example, to the mass.

A cluster algorithm can be used to assign the measurement points 410 to different clusters 411 for different usage scenarios. The clusters 411 and/or the centroids of the clusters 411 can then be used as a classification unit. As an alternative or in addition, the classification unit can be determined based on linear discriminant analysis (LDA) on the basis of the multiplicity of measurement points 410.

The (control) device 111 can therefore be configured, for a usage event or for a usage situation of the motorcycle 110, to acquire measurement values 313 of the spring forces 201, 202 (or the vertical forces 211, 212) in order to determine estimated values 315 of state variables of the motorcycle 110 based thereon. The usage scenario of the motorcycle 110 can be determined for the usage event (for example during a journey) of the motorcycle 110 on the basis of the estimated values 315 of the state variables.

The device 111 may also be configured to store the usage scenarios of the individual usage events of the motorcycle 110 and/or to provide same to a unit external to the vehicle. This information can be determined and provided by a multiplicity of different motorcycles 110. It is thus possible for the unit external to the vehicle to determine a precise overview of the typical usage of motorcycles 110, which can be taken into account, for example, in the development of a new type of motorcycle.

As an alternative or in addition, the device 111 may be configured to set and/or adjust one or more operating parameters of the motorcycle 110 for a usage event depending on the determined usage scenario of the motorcycle 110 and/or depending on the estimated values 315 of the one or more state variables. For example, one or more operating parameters of a rider assistance function, such as a distance and/or speed controller, and/or a brake function, such as ABS, can be set and/or adjusted. The comfort and/or the riding safety of the motorcycle 110 can thus be increased.

FIG. 5a shows a flowchart of a (possibly computer-implemented) method 500 for determining a (load) state of a single-track vehicle 110, in particular a motorcycle. The method 500 comprises, during a usage situation or during a usage event of the vehicle 110 (for example during a journey of the vehicle 110), determining 501 measurement values 313 of spring forces 201, 202 of a suspension system 118 of the front wheel 116 and a suspension system 118 of the rear wheel 116 of the vehicle 110 (using one or more sensors of the vehicle 110).

The method 500 also comprises determining 502, on the basis of the measurement values 313 of the spring forces 201, 202, estimated values 315 of a plurality of state variables of the vehicle 110, which estimated values each relate to a load of the vehicle 110 (with a pillion passenger and/or with luggage). In particular, an estimated value 315 of the mass of the vehicle 110 and/or an estimated value 315 of the (horizontal) position of the center of gravity 130 of the vehicle 110 can be determined.

The method 500 furthermore comprises operating 503 the vehicle 110 depending on the estimated values 315 of the state variables and/or providing the estimated values 315 of the state variables or data based thereon to a unit external to the vehicle. For example, one or more operating parameters of the vehicle 110 can be set depending on the estimated values 315 of the state variables (specifically for the respective usage situation). The comfort and/or the safety of the vehicle 110 can thus be increased.

FIG. 5b shows a flowchart of a (possibly computer-implemented) method 510 for determining a usage scenario of a single-track vehicle 110, in particular a motorcycle. The features of the method 510 can be combined individually or in combination with the features of the method 510.

The method 510 comprises, during a usage situation of the vehicle 110 (for example during a journey), determining 511 estimated values 315 of a plurality of state variables of the vehicle 110, which estimated values each relate to a load of the vehicle 110 (with a pillion passenger and/or with luggage). In particular, an estimated value 315 of the mass of the vehicle 110 and/or an estimated value 315 of the (horizontal) position of the center of gravity 130 of the vehicle 110 can be determined.

The method 510 also comprises selecting 512, on the basis of the estimated values 315 of the state variables, a usage scenario of the vehicle 110 in the usage situation from a set of different usage scenarios. The method 510 furthermore comprises operating 513 the vehicle 110 depending on the selected usage scenario and/or providing the selected usage scenario to a unit external to the vehicle. For example, one or more operating parameters of the vehicle 110 can be set depending on the selected usage scenario (specifically for the respective usage situation). The comfort and/or the safety of the vehicle 110 can thus be increased.

The present disclosure is not restricted to the exemplary embodiments shown. In particular, it should be noted that the description and the figures are intended to illustrate the principle of the proposed methods, devices and systems purely by way of example.

1.-15. (canceled)

16. A device for determining a state of a single-track vehicle, wherein the device is configured, during a usage situation of the vehicle, to:
determine measurement values of spring forces of a suspension system of a front wheel and of a suspension system of a rear wheel of the vehicle;
determine, on the basis of the measurement values of the spring forces, estimated values of a plurality of state variables of the vehicle, which estimated values each relate to a load of the vehicle; and
operate the vehicle depending on the estimated values of the state variables, and/or to provide the estimated values of the state variables or data based thereon to a unit external to the vehicle.

17. The device according to claim 16, wherein the device is configured to:
determine, on the basis of the measurement values of the spring forces and based on a speed ratio of the suspension system of the front wheel and/or the suspension system of the rear wheel of the vehicle, corresponding measurement values of vertical forces, which act on the front wheel and on the rear wheel of the vehicle in a vertical direction, wherein the speed ratio of the suspension system depends on a ratio between a suspension travel along a suspension direction of the suspension system and a vertical travel, corresponding to the suspension travel, along the vertical direction; and
determine the estimated values of the state variables on the basis of the measurement values of the vertical forces.

18. The device according to claim 17, wherein the device is configured to:
determine, on the basis of the measurement value F_{s,f} of the spring force of the suspension system of the front wheel and based on a speed ratio τ_{f} of the suspension system of the front wheel, the corresponding measurement value F_{z,f} of the vertical force on the front wheel as
F_{z,f}=F_{s,f}*τ_{f};
determine, on the basis of the measurement value F_{s,r} of the spring force of the suspension system of the rear wheel and based on a speed ratio τᵣ of the suspension system of the rear wheel, the corresponding measurement value F_{z,r} of the vertical force on the rear wheel as
F_{z,r}=F_{s,r}*τᵣ; and
determine the estimated values of the state variables on the basis of the measurement value F_{z,f} of the vertical force on the front wheel and on the basis of the measurement value F_{z,r} of the vertical force on the rear wheel.

19. The device according to claim 17, wherein
Xₛ₁-Xₛ₂ is the suspension travel of the suspension system of the front wheel or the rear wheel between a first suspension state and a second suspension state of the suspension system;
Z_{w2}-Z_{w1} is the corresponding vertical travel of the front wheel or the rear wheel between the first suspension state and the second suspension state of the suspension system; and
the speed ratio τ of the suspension system of the front wheel or the rear wheel is given by
$$τ = \frac{{X}_{s 1} - {X}_{s 2}}{{Z}_{w 2} - {Z}_{w 1}} .$$

20. The device according to claim 16, wherein the state variables include
a mass m of the vehicle; and/or
a position x_{cog} of a center of gravity of the vehicle.

21. The device according to claim 16, wherein the device is configured to:
determine the estimated values of the one or more state variables of the vehicle based on one or more state variable models; wherein the one or more state variable models each have one or more model parameters; and
determine values of the one or more model parameters and to use same to determine the estimated values of the one or more state variables of the vehicle.

22. The device according to claim 21, wherein the one or model parameters include
a vertical acceleration of the vehicle;
a roll angle of the vehicle; and/or
an aerodynamic force acting on the vehicle.

23. The device according to claim 6, wherein the one or more state variable models include
$$m = \frac{{a}_{z} * g * ( {F}_{z , f} + {F}_{z , r} )}{cos ( δ )}$$
wherein
m is a mass of the vehicle;
a_{z} is a vertical acceleration of the vehicle;
δ is a roll angle of the vehicle;
g is the gravitational field strength;
F_{z,f} is the measurement value of a vertical force of the suspension system of the front wheel, which is dependent on the measurement value of the spring force of the suspension system of the front wheel; and
F_{z,r} is the measurement value of a vertical force of the suspension system of the rear wheel, which is dependent on the measurement value of the spring force of the suspension system of the rear wheel; and/or
$${x}_{cog} = \frac{{x}_{wb} * {F}_{z , r} - {z}_{l} * {F}_{aero}}{m * g}$$
wherein
x_{wb} is a horizontal distance between an axle of the wheel and an axle of the rear wheel of the vehicle;
Fₐₑᵣₒ is an aerodynamic force acting on the vehicle; and
zₗ is an effective height at which the aerodynamic force acts on the vehicle.

24. The device according to claim 16, wherein the device is configured, at a sequence of successive times, to:
determine respective current measurement values of the spring forces; and
update the estimated values of the state variables using a recursive determination unit based on the respective current measurement values of the spring forces.

25. The device according to claim 16, wherein the device is configured to:
select, on the basis of the estimated values of the state variables, a usage scenario of the vehicle in the usage situation from a set of different usage scenarios; and
operate the vehicle depending on the selected usage scenario, and/or to provide the selected usage scenario to the unit external to the vehicle.

26. The device according to claim 25, wherein the device is configured to select the usage scenario of the vehicle in the usage situation using a machine-trained classification unit.

27. The device according to claim 25, wherein the set of different usage scenarios includes
a first usage scenario in which a rider is riding alone without luggage;
a second usage scenario in which the rider is riding with a pillion passenger;
a third usage scenario in which the rider is riding alone with luggage; and/or
a fourth usage scenario in which the rider is riding with a pillion passenger and with luggage.

28. A device for determining a usage scenario of a single-track vehicle, wherein the device is configured, during a usage situation of the vehicle, to:
determine estimated values of a plurality of state variables of the vehicle, which estimated values relate to a load of the vehicle;
select, on the basis of the estimated values of the state variables, a usage scenario of the vehicle in the usage situation from a set of different usage scenarios; and
operate the vehicle depending on the selected usage scenario, and/or to provide the selected usage scenario to a unit external to the vehicle.

29. A method for determining a state of a single-track vehicle, wherein the method, during a usage situation of the vehicle, comprises:
determining measurement values of spring forces of a suspension system of a front wheel and a suspension system of a rear wheel of the vehicle;
determining, on the basis of the measurement values of the spring forces, estimated values of a plurality of state variables of the vehicle, which estimated values each relate to a load of the vehicle; and
operating the vehicle depending on the estimated values of the state variables, and/or providing the estimated values of the state variables or data based thereon to a unit external to the vehicle.

30. A method for determining a usage scenario of a single-track vehicle, wherein the method, during a usage situation of the vehicle, comprises:
determining estimated values of a plurality of state variables of the vehicle, which estimated values each relate to a load of the vehicle;
selecting, based on the estimated values of the state variables, a usage scenario of the vehicle in the usage situation from a set of different usage scenarios; and
operating the vehicle depending on the selected usage scenario, and/or providing the selected usage scenario to a unit external to the vehicle.
